(19) United States
(12) Patent Application Publication
(10) Pub. No.: US 2026/0290399 A1
(43) Pub. Date: Sep. 24, 2026

(54) GENERATING VIDEO CONTENT FROM TEXT INPUT

(71) Applicant: Adobe Inc., San Jose, CA (US)

(72) Inventors: Ishita Dasgupta, South San Francisco, CA (US); Stefano Petrangeli, Mountain View, CA (US); Somdeb Sarkhel, San Jose, CA (US); Saayan Mitra, San Jose, CA (US); Deana Durham, La Honda, CA (US)

(73) Assignee: Adobe Inc., San Jose, CA (US)

(21) Appl. No.: 19/083,844

(22) Filed: Mar. 19, 2025

(51) Int. Cl. G11B 27/02; G06F 40/279; G06F 40/40; G06T 11/00; G10L 13/02

(52) U.S. Cl. CPC G11B 27/02; G06F 40/279; G06F 40/40; G06T 11/00; G06T 2200/24; G10L 13/02

(57) ABSTRACT

Video content creation is described. A video generation system employs a machine learning system to automate video generation, from textual input to final video output. The video generation system receives a textual description and optional parameters as user input and uses this input to generate a prompt for input to at least one machine learning model. The prompt causes the at least one machine learning model to output a summary understanding of the user-provided inputs along with a scene-by-scene script for a video. Based on the script, the video generation system automatically imports or generates visuals, synthesizes narration, and selects audio for each video scene. The video generation system is then configured to adjust individual scene elements for optimal cohesion and timing during video playback. In some implementations, the video generation system produces multiple video variations, enabling users to ideate by visualizing and comparing different options.

### BACKGROUND

Digital videos are an increasingly popular medium for content creators to share information, entertain, and engage with diverse audiences across various platforms. To satisfy the growing demand for such video content, there exists a need for efficient, cost-effective production methods to facilitate video content generation. Existing approaches for video content creation are time intensive and are limited by a content creator's skill and ability to manually distill a concept into a complete video. For instance, in the context of educational or informational videos, conventional approaches are entirely dependent on a content creator's ability to convert textual information into engaging video content and require intensive human intervention in the form of user inputs to one or more computing devices.

### SUMMARY

Video content creation techniques are described that address technical challenges facing conventional video generation techniques. A video generation system employs a machine learning system to automate video generation, from textual input to final video output. The video generation system receives a textual description and optional parameters as input from a user and uses this input to generate a script using at least one machine learning model.

The video generation system provides a summary understanding of the user-provided inputs, allowing users to confirm or refine inputs during the video generation process. The video generation system automatically imports or generates visuals, synthesizes narration, and selects audio, adjusting scene elements for optimal cohesion and timing. In some implementations, the video generation system produces multiple video variations, enabling users to ideate by visualizing and comparing different options.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ video content generation techniques described herein.

FIG. 2 depicts a system in an example implementation showing operation of a video generation system of FIG. 1 in greater detail as generating video content based on text input and parameters.

FIG. 3 depicts a system in an example implementation showing output of a user interface used to obtain the text input and parameters used by the video generation system of FIG. 1 in generating video content.

FIG. 4 depicts a system in an example implementation showing operation of a prompt generation module of FIG. 2 in greater detail as generating a prompt based on text input.

FIG. 5 depicts a system in an example implementation showing operation of a script generation module of FIG. 2 in greater detail as generating a video script based on a prompt of FIG. 4.

FIG. 6 depicts an example implementation of scenes of video content generated based on a video script generated by the script generation module of FIG. 2.

FIG. 7 is a flow diagram depicting an algorithm as a step-by-step procedure in an example implementation of operations performable for generating video content based on text input.

FIG. 8 illustrates an example system including various components of an example device that can be implemented as any type of computing device as described and/or utilize with reference to the previous figures to implement the techniques described herein.

### DETAILED DESCRIPTION

### Overview

Conventionally, creating video content is a completely manual process that requires content creators to manually source and upload video clips, image content displayed as part of the video, text content displayed as part of the video, background music, narration audio, dialogue, and so forth. After manually souring and uploading this content to a video creation platform, content creators are further required to manually order and/or overlay different types of content to achieve a desired playback. This manual process involves tedious inputs for even the most experienced content creators and is prone to human error. For instance, failing to align audio with corresponding video content is immediately perceived by a viewer and requires significant efforts to correct.

Some conventional approaches to video content creation are designed to automate a small portion of the overall workflow for generating video content. For instance, some conventional systems offer templates for video content creation, which include pre-defined settings that allow content creators to insert video data in a manner that conforms to the pre-defined settings. While such template-based systems offer some level of automation, template-based systems are inherently limited in their flexibility and ability to produce customized video content. For instance, the rigid structure of pre-defined templates constrains creativity and fails to adapt to diverse user needs or unique content requirements. Further, such conventional template-based video creation systems typically require significant manual input for content selection and arrangement, which is time-consuming.

As yet another drawback, template-based video creation systems fail to maintain coherence and natural flow when dealing with complex or nuanced topics, as pre-defined templates are unable to adapt to integrate varied content elements. Consequently, videos produced using conventional template-based video creation systems appear generic or disjointed, failing to fully engage viewers or effectively convey an intended message.

To address these conventional shortcomings, the described techniques automate a workflow that receives, as input from a content creator, a textual description of subject matter to be conveyed in a digital video. To accommodate scenarios where a content creator does not know exactly what they want conveyed in the digital video, the described techniques additionally prompt a content creator to define parameters for the video content, such as a “mood,” an “intended audience,” a “style” for the video, and so forth, in addition to user-provided textual input describing desired video content. Based on the user-provided input text, and optionally further based on user-designated parameters, a video generation system generates a video. In some implementations, the video generation system is configured to generate multiple different instances of a video, thus providing a user with tangible examples of how a resulting video will be experienced by a viewer, thus enabling the user to make informed decisions regarding how text input and parameter selections can be curated to achieve a desired output video.

As part of generating each video, the video generation uses input text and/or user-specified parameters to describe an overall flow for a textual script of the video (e.g., to be included as audio content output during playback “of the video, textual content displayed as subtitles during playback of the video, combinations thereof, and so forth), as well as content displayed during playback of the video (e.g., still images, one or more video frames, combinations thereof, and other information that is visually perceptible by a viewer during playback of the video). To generate the script, the video generation system generates a prompt that initiates generation of the script by a machine learning system. In implementations, the prompt is generated by populating a template with information describing the user-provided input text and any user-provided parameters for the video. Inputting the prompt to the machine learning system causes the machine learning system to generate a framework script that describes, for each of a plurality of video scenes, one or more visual keywords and narration text for the scene.

In some implementations, the prompt further causes the machine learning system to output a summary of the machine learning system's understanding of a user's requirements as defined by input and parameters for the video. Such a summary of the machine learning system's understanding of user requirements enables the user to confirm whether user-provided inputs are being interpreted as intended by the user, before the video generation system generates a video. This advantageously avoids unnecessary waste of computational resources (e.g., processing power, memory consumption, etc.) that would otherwise be consumed if the user were unable to preview how the video generation system interprets user inputs before generation and playback of the resulting video.

The described techniques thus enable a user with opportunities to modify (e.g., add, adjust, delete, or combinations thereof) input provided to the video generation system, prior to completion of generating video content. This feedback mechanism provided by the described techniques enables an ongoing conversation between a user and the video generation system, enabling iterative refinements at various stages of the video generation pipeline. The framework script generated by the machine learning system is output for display via a user interface with at least one prompt for a user to change scene information (e.g., modify visual keywords, narration text, combinations thereof, and so forth) and accept scene information.

In response to receiving user input accepting scene information for each scene in the script, the video generation system automatically imports or generates relevant visuals for each scene, synthesizes voice-over narration, and selects appropriate audio data. The video generation system then adjusts these elements to ensure cohesion and optimal timing across scenes. For example, the video generation system is configured to modify a number of images included in a scene, a playback duration of one or more scenes, and scene transition times based on a length of synthesized narration (e.g., for a subset of scenes or for an entirety of the video).

The video generation system is then configured to assemble the scenes into a final video and present the video for output in a user interface. In some implementations, the video generation system is configured to generate multiple video variations based on user-provided input (e.g., displaying different videos in a single user interface to facilitate comparison). The described techniques thus not only inspire content creators to ideate, but further advantageously enable users to visualize how different content selections affect the resulting video, enhancing the video generation system's ability to produce customized, engaging content that conveys an intended message.

The described techniques offer significant technical advantages over conventional approaches by providing an end-to-end automated solution for video content creation. Unlike manual video generation processes or template-based systems, the described techniques leverage machine learning to generate customized, coherent videos directly from textual input and user-defined parameters. The ability to produce multiple video variations from the same input criteria, coupled with a user-guided iterative refinement process, enables content creators to visualize and fine-tune video output efficiently. This not only saves computational resources by allowing preview and adjustment before final rendering, but also enhances creativity and adaptability to diverse content needs. Furthermore, the automatic adjustment of visual and audio elements ensures optimal timing and cohesion across video scenes, avoiding the limitations of conventional systems, which involve rigid templates and error-prone manual editing. These technical advancements result in a more streamlined, flexible, and resource-efficient video creation process that conventional methods cannot achieve. Further discussion of these and other examples is included in the following discussion and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “diffusion model” is a type of generative machine-learning model that is used for digital content creation (e.g., digital video, digital images, digital audio, and so forth). In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Video Generation Environment

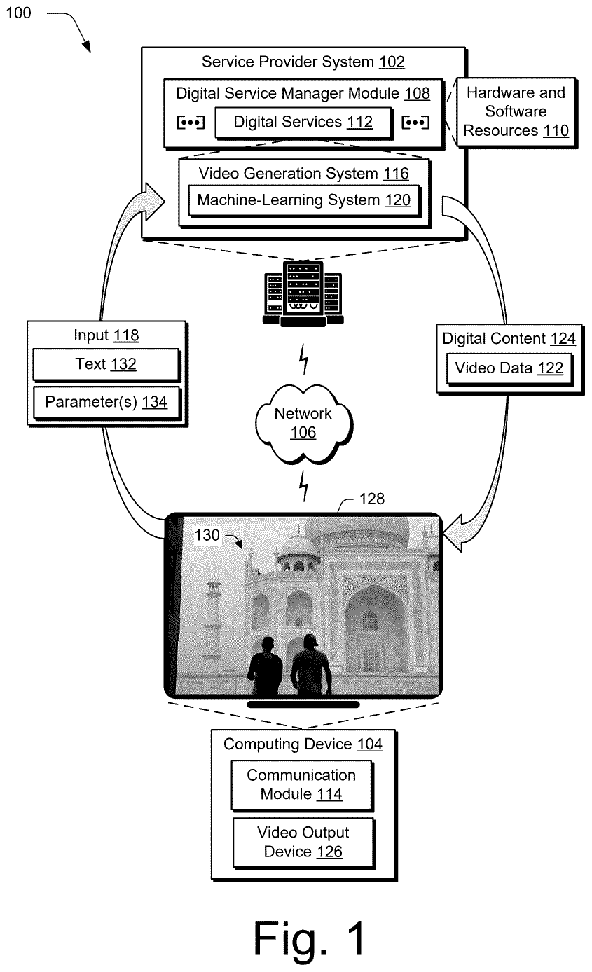

FIG. 1 is an illustration of a digital medium environment 100 in an example implementation that is operable to employ video content generation techniques described herein. The illustrated environment 100 includes a service provider system 102 and a computing device 104 that are communicatively coupled, one to another, via a network 106. Computing devices are configurable in a variety of ways.

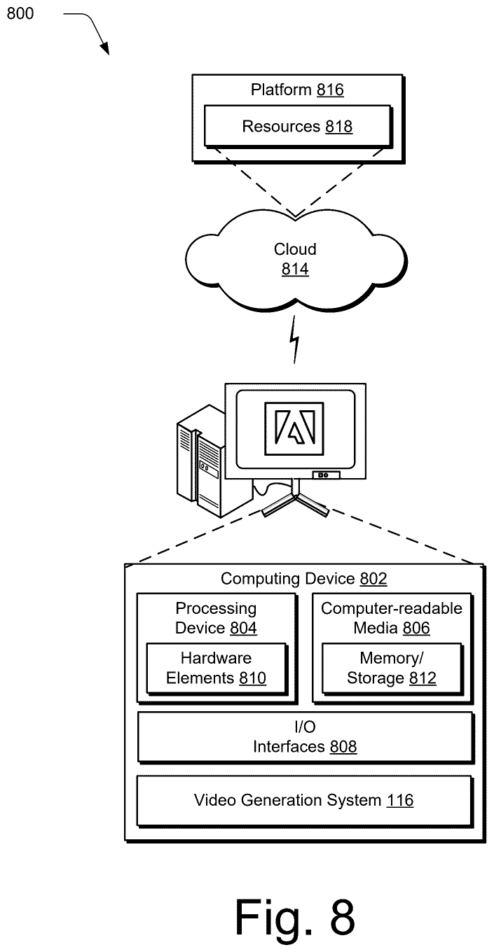

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 8.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices (e.g., computing device 104).

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a video generation system 116, although implementation of the video generation system 116 locally by the computing device 104 is also supported. To begin algorithm 700, an input describing a video to be generated is received (block 702). The video generation system 116 is configured to receive an input 118 and process the input by a machine-learning system 120 to generate video data 122 (e.g., using generative AI) as part of digital content 124. Video data 122 received by the computing device 104 is configured for output via at least one video output device 126. In implementations, the video output device 126 is representative of one or more hardware components such as a display screen, monitor, television, projector, or other visual output hardware capable of presenting video content (e.g., via a user interface 128). In some implementations, the video output device 126 is integrated into computing device 104 (e.g., a laptop or smartphone display). Alternatively or additionally, the video output device 126 is implemented as a separate peripheral device connected to the computing device 104.

In the illustrated example of FIG. 1, user interface 128 displays playback of a video 130, as represented by the video data 122 generated based on text 132 of the input 118 and optionally one or more parameters 134 defined by the input 118. In implementations, text 132 is representative of a user-provided description of the desired video content, such as “I want to popularize my travel agency in India.” This textual input serves as the primary basis for generating a video script and overall content included in the video data 122. The one or more parameters 134 are representative of various user-specified settings that further refine the video creation process, as described in further detail below. For instance, in some implementations parameters 134 are representative of selections, made by a user of the computing device 104, of options presented by the video generation system 116 (e.g., via user interface 128 prior to generation of the video data 122).

For example, the video generation system 116 transmits parameter selection options to the computing device 104 in the form of digital content 124. As specific example, parameter selection options enable defining a target audience for video data 122 from options such as “Friends & family,” “Existing connections,” or “Potential clients.” As another specific example, parameter selection options enable defining an overall mood of the video data 122 from options such as “Travel” or “Happy,” and defining a style of the video data 122 from options such as “Personal,” “Informational,” or “Promotional.” Thus, parameters 134 that are optionally included in the input 118 help tailor the video data 122 to the specific needs and preferences of a user of the computing device 104. Together, the text 132 and one or more parameters 134 provide the video generation system 116 with a comprehensive understanding of user requirements, enabling creation of customized and relevant video content.

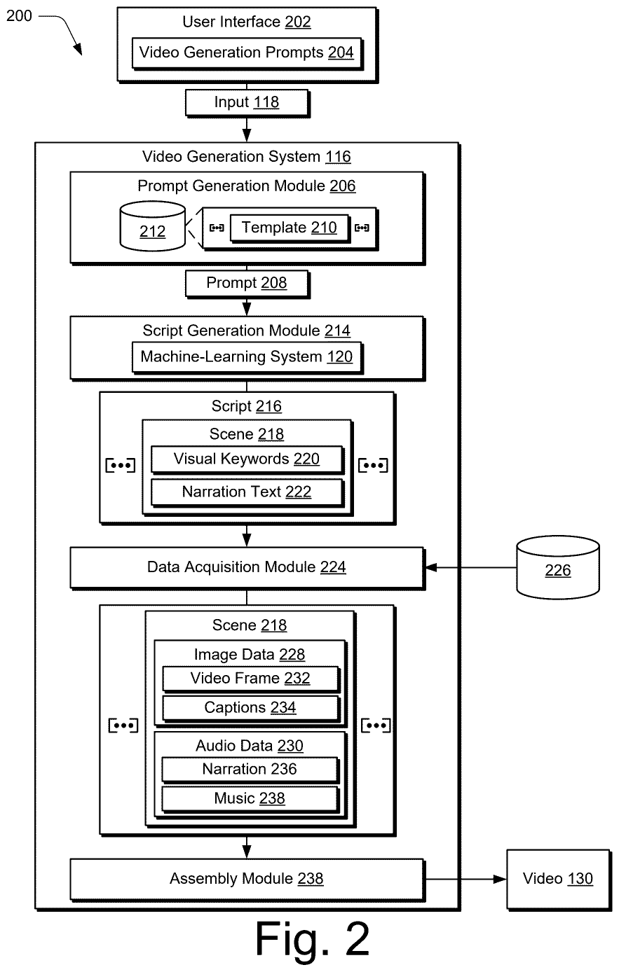

The video generation system 116 is configured to leverage the text 132, and optionally one or more parameters 134, as part of generating the video data 122 (e.g., as a text-to-video diffusion model implemented by the machine-learning system 120). For a further description of the video generation system 116 generating video data 122 based on input 118, consider FIG. 2.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Video Content Generation From Text Input

The following discussion describes video data generation techniques based on text input that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

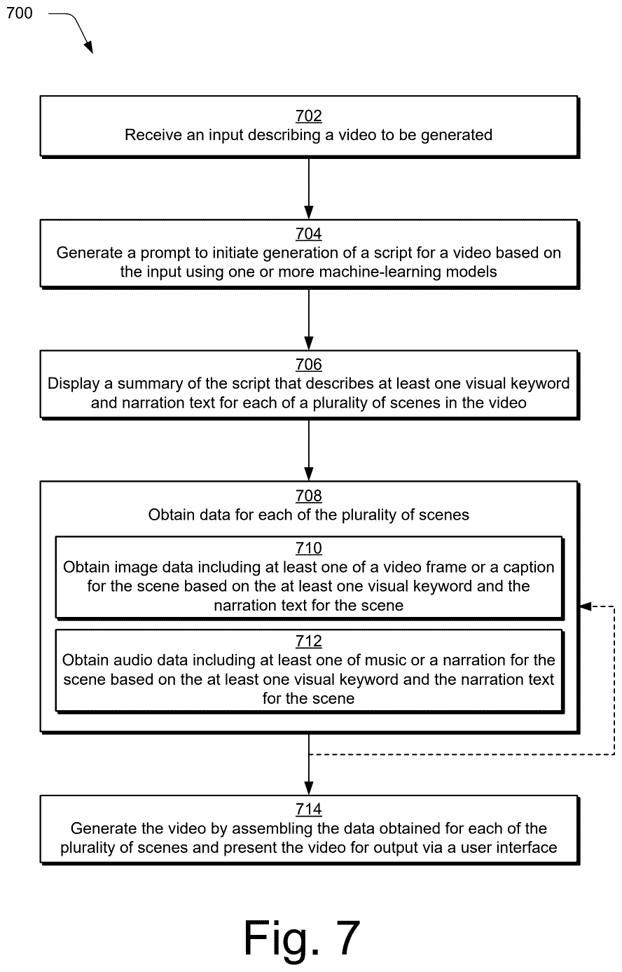

FIG. 7 is a flow diagram depicting an algorithm 700 as a step-by-step procedure in an example implementation of operations performable for generating video content based on text input. In portions of the following discussion, reference is made interchangeably with the algorithm 700 of FIG. 7.

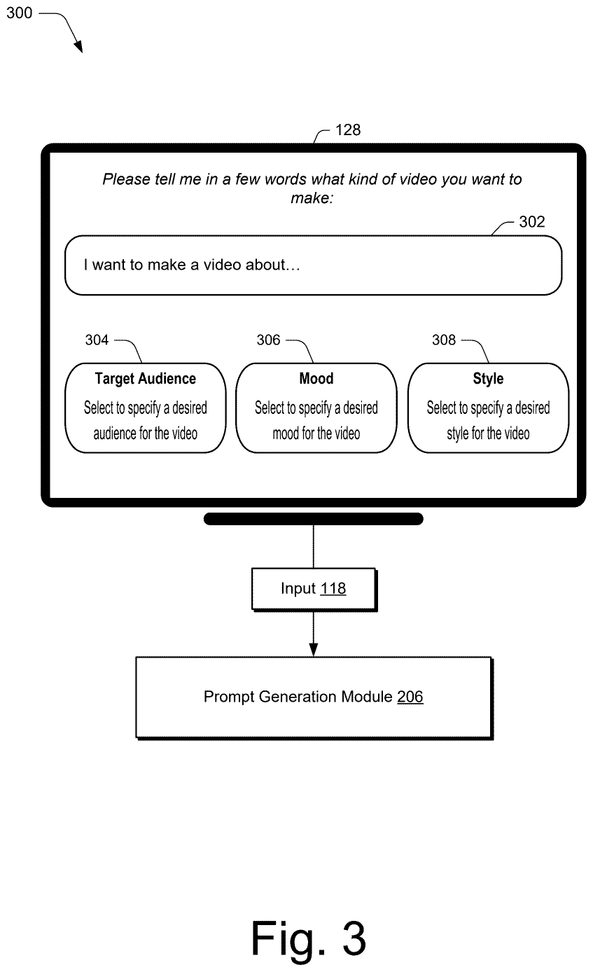

FIG. 2 depicts a system 200 in an example implementation showing operation of the video generation system 116 of FIG. 1 in greater detail as generating video data based on input 118. In the illustrated example of FIG. 2, the video generation system 116 is depicted as receiving input 118 via user interaction with a user interface 202. The user interface 202, for example, is representative of a user interface displayed via computing device 104, such that the user interface 202 represents an instance of user interface 128. In some implementations, the user interface 202 is configured as including one or more video generation prompts 204, which are configurable as one or more user interface elements to request user feedback describing requirements for generating the video data 122. For a further description of an example configuration of the user interface 202 configured to facilitate transmission of input 118 (e.g., from the computing device 104 to the video generation system 116), consider FIG. 3.

FIG. 3 depicts a system 300 in an example implementation showing output of the user interface 202 used to obtain the text 132 and parameters 134 as input 118 used by the video generation system 116 in generating video content. In the illustrated example of FIG. 3, user interface 202 is depicted as an instance of user interface 128 displayed via the video output device 126 of computing device 104. The user interface 128 includes a prompt for feedback describing subject matter to be conveyed via a video (e.g. “Please tell me in a few words what kind of video you want to make:”). The user interface 128 includes an input field 302, where users can enter text describing the video they want to create. Text entered to the input field 302 via user input is representative of text 132 in the input 118, which is provided to a prompt generation module 206 of the video generation system 116.

In some implementations, the input 118 includes only text 132, such that the video data 122 generated by the video generation system 116 is created using only text input to the input field 302. In other implementations, the input 118 includes one or more parameters 134 in addition to the text 132. To facilitate user input defining one or more parameters 134, the user interface 128 includes different parameter selector components: audience selector 304, mood selector 306, and style selector 308. In implementations, the user interface 128 is configured to present parameter selector components according to one or multiple configurations to accommodate various user preferences and input requirements. For instance, individual ones of the parameter selector component are configurable as drop-down menus, selectable radio buttons, checkboxes, text entry fields, combinations thereof, and so forth.

For instance, consider an example implementation where the audience selector 304 is configured as a drop-down menu containing pre-defined options such as “Friends & family,” “Existing connections,” “Potential clients,” “Local community,” “Influencers & thought leaders,” “Working professionals,” “Students,” and “Kids.” This example configuration allows a user of the computing device 104 to quickly select a target audience from a curated list. In some implementations, the curated list may be pre-defined by the video generation system 116, defined by a user of the computing device 104, or combinations thereof. Continuing this example implementation, the mood selector 306 is configured as a set of radio buttons, enabling a user of the computing device 104 to specify a desired mood for the video from options like “Travel,” “Happy,” “Inspirational,” “Informative,” or “Exciting.” By enabling specification of a “mood” parameter for the video data 122, the video generation system 116 ensures consistency in the video's emotional tone. Continuing this example implementation, the style selector 308 is configured as a series of checkboxes, allowing users to select one or more styles that can be combined in the video creation process. Options for selectable style parameters include “Personal,” “Informational,” “Promotional,” “Cinematic,” “Animated,” “Documentary-style,” and so forth.

Although not depicted in the illustrated example of FIG. 3, in some implementations the video generation system 116 is configured to prompt feedback defining the input 118 by including a custom parameter entry field in the user interface 128, where a user of the computing device 104 is able to input specific keywords or phrases to further refine the video generation process. Such a custom parameter entry field could be accompanied by a “+” button or icon, allowing users to add multiple custom parameters as needed. In various implementations, the user interface 128 presents different combinations of the illustrated example parameter selector components. For example, one configuration might display only the audience selector 304 and mood selector 306, prioritizing simplicity for users who prefer a streamlined input process. Another configuration could present all selector components along with additional options such as video length (implemented as a slider), color scheme (presented as a color picker tool), combinations thereof, and so forth.

Thus, the illustrated example of FIG. 3 is not intended to be limiting, and the user interface 128 is configurable to display additional or fewer parameter selector components based on the specific requirements of the video generation system 116, preferences of a user of the computing device 104, or combinations thereof. For instance, in implementations the user interface 128 includes a language selector (e.g., configured as a drop-down menu) to specify the primary language for the video content, a topic selector (e.g., configured as a hierarchical menu) to narrow down the subject matter more precisely, combinations thereof, and so forth.

In some implementations, the user interface 128 is configurable to dynamically adjust the displayed parameter selector components based on the text input provided in the input field 302. For instance, if the text input mentions “educational content,” the user interface 128 is configurable to automatically display an age group selector or a complexity level slider to further refine the video's target audience and content depth. Furthermore, in some implementations the user interface 128 includes a “custom parameter” section, where users can define their own parameters and input values, providing maximum flexibility for tailoring the video generation process to specific user needs. This feature could be particularly useful for advanced users or those with unique video requirements not covered by pre-defined parameter options as populated by the video generation system 116.

Returning to FIG. 2, based on feedback to the user interface 202, and optionally one or more video generation prompts 204 included therein, the input 118 is provided to the prompt generation module 206 of the video generation system 116. Based on the input, a prompt is generated to initiate generation of a script using one or more machine-learning models (block 704). The prompt generation module 206, for instance, uses the input 118 to generate a prompt 208. The prompt 208 is configured to initiate generation of a script for the video 130, based on the input 118 defined by text 132 received via user interface 202 and optionally further based on one or more parameters defined via the user interface 202.

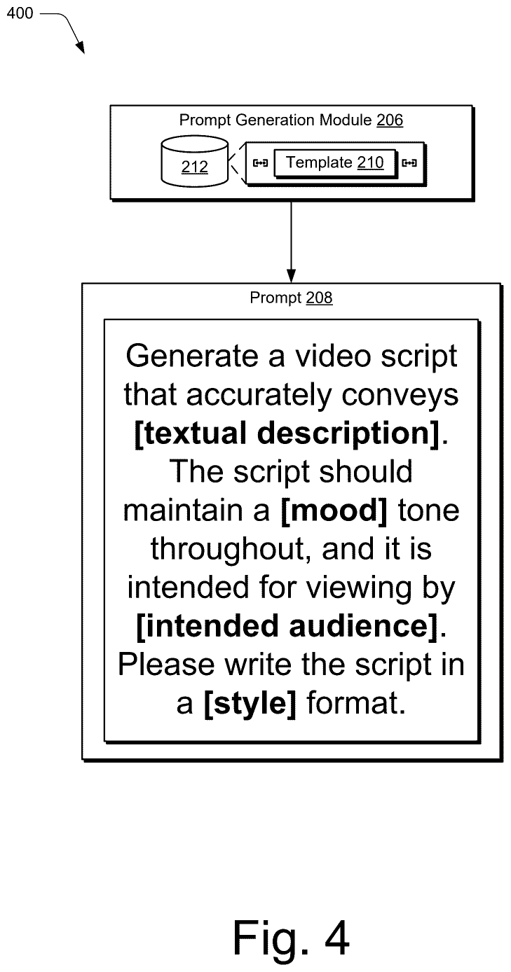

The prompt generation module 206 is configured to generate the prompt 208 in a variety of ways, including use of one or more templates 210 (illustrated as stored in a storage device 212) that are “filled in” by the prompt generation module 206 (e.g., using natural language processing). An example of which is described below and shown in FIG. 4.

FIG. 4 depicts a system 400 in an example implementation showing operation of the prompt generation module 206 in greater detail as generating prompt 208 based on input 118. In order to aggregate the information represented by input 118 (e.g., text 132 and optionally one or more parameters 134), a template 210 configured to employ text is used. In the illustrated example, the prompt 208 represents text of a template 210 that is populated based on input 118 using bold font encompassed by brackets, contrasted with text of the template 210 that persists (e.g., is not modified) based on the input 118. For instance, in the illustrated example of FIG. 4, the template is used to generate a prompt that instructs the machine-learning system 120 to “Generate a video script that accurately conveys [textual description]. The script should maintain a [mood] tone throughout, and it is intended for viewing by [intended audience]. Please write the script in a [style] format.”

The prompt generation module 206 is thus configured to generate the prompt 208 by replacing portions of the template 210 represented by bracketed bold font based on information described by the input 118. For instance, consider an example scenario where the input 118 received from the example user interface 128 of FIG. 3 indicates that a user of the computing device 104 wants to achieve “popularizing my travel agency in India,” selected a “travel” option from the mood selector 306, selected “social media followers” “travel enthusiasts” options from the audience selector 304, and selected a “personal” option from the style selector 308. In this example scenario, the prompt generation module 206 leverages the template 210 to generate a prompt 208 that instructs the machine-learning system 120 to “Generate a video script that accurately conveys [popularizing my travel agency in India]. The script should maintain a [travel] tone throughout, and it is intended for viewing by [social media followers and travel enthusiasts]. Please write the script in a [personal] format.”

Although a specific example template is illustrated and described with respect to generating prompt 208, the described techniques are not so limited and the prompt generation module 206 is configured to leverage a variety of different templates 210. For instance, individual templates 210 are configurable in various ways, offering flexibility and customization in the video generation process. For example, an example template 210 is structured to emphasize different aspects of the video data 122 or to provide more specific instructions to the machine-learning system 120. One example template configuration focuses on a scene-by-scene breakdown, instructing the machine-learning system 120 to “Create a video script with [number of scenes] scenes that conveys [textual description]. For each scene: Describe the visual elements in a [mood] style. Provide narration text suitable for [intended audience]. Suggest background music that fits a [style] format. Ensure continuity and flow between scenes.”

Another example template is configurable to prioritize storytelling elements, prompting the machine-learning system 120 to “Develop a [style] video script for [intended audience] that tells the story of [textual description]. Include: a compelling opening hook; key points or benefits, presented in a [mood] tone; a clear call-to-action; maintain engagement throughout by incorporating [specific storytelling techniques].” For more technical or educational content, a template 210 instructs the machine-learning system 120 to “Generate a [style] educational video script about [textual description] for [intended audience]. The script should begin with an overview of the topic, break down complex ideas into [number] easily digestible sections, use analogies or examples relatable to the [intended audience], and conclude with a summary and practical applications. Maintain a [mood] tone to keep viewers engaged.” In some implementations, templates 210 are dynamically generated or modified (e.g., by the video generation system 116) based on the specific input 118 received, or the prompt generation module 206 is configured to select from multiple templates 210 based on the input 118, choosing the most appropriate template for given parameters 134. This approach allows for even greater customization of the prompt 208 generated for the machine-learning system 120, enhancing the video generation system 116's ability to produce tailored video data 122 based on the input 118.

Returning to FIG. 2, the prompt 208 is provided as input to a script generation module 214, which implements at least one machine-learning system 120 to generate a script 216 based on the prompt 208. The script 216 defines, for each scene 218 of a plurality of scenes to be included in the video 130, one or more visual keywords 220 and narration text 222 for the scene. The script 216 generated by the script generation module 214 thus provides a framework for the video 130, defining key elements for each scene 218.

The one or more visual keywords 220 generated for a scene 218 represent visual content that will be presented to viewers during video playback. These visual keywords 220 may describe specific images, video clips, animations, graphical elements, or combinations thereof, which collectively convey the scene's content visually. For example, visual keywords 220 may include descriptions such as “aerial view of Taj Mahal,” “bustling spice market,” or “serene backwaters with houseboats.” The machine-learning system 120 generates these visual keywords 220 based on the prompt 208, ensuring they align with the overall theme and style specified in the input 118.

Alongside the visual keywords 220, the script 216 includes narration text 222 for each scene 218. This narration text 222 represents the audible commentary or description that accompanies the visual elements, which may be heard by viewers as voice-over narration, displayed as on-screen subtitles, or both, during video playback. The narration text 222 is also generated by the machine-learning system 120 in response to the prompt 208, ensuring it complements the visual keywords 220 and maintains the desired tone, style, and audience focus specified in the input 118. Together, the visual keywords 220 and narration text 222 provide a comprehensive outline for each scene 218, guiding the subsequent stages of video production in creating cohesive and engaging content that aligns with the user's initial input and parameters. Thus, a summary of the script that describes at least one visual keyword and narration text for each of a plurality of scenes in the video is displayed (block 706).

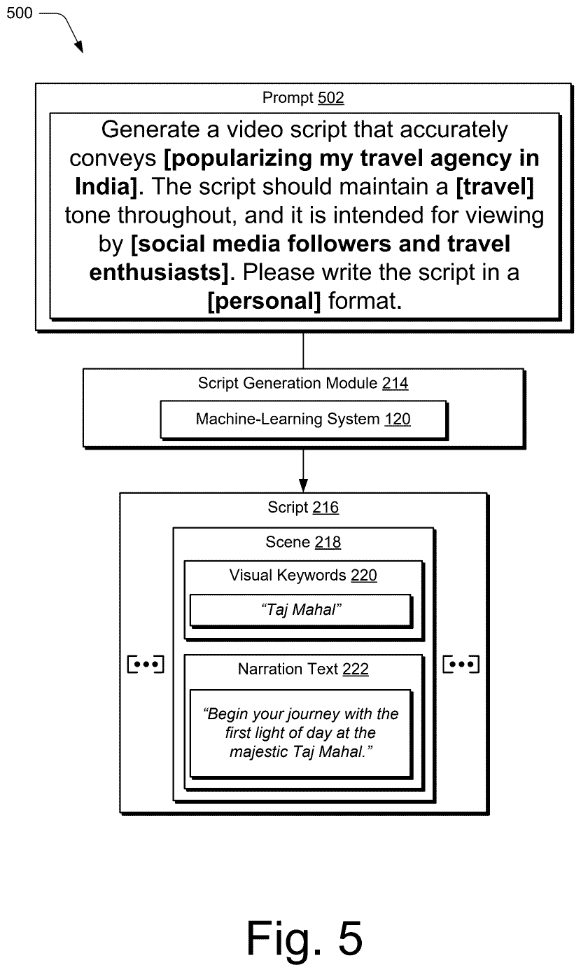

FIG. 5 depicts a system 500 in an example implementation showing operation of the script generation module 214 in greater detail as generating script 216 based on a prompt 208. In the illustrated example of FIG. 5, prompt 502 represents an instance of prompt 208 generated by filling out a template 210 based on the input 118 received via the user interface 128 of FIG. 3. The prompt 502 instructs the machine-learning system 120 to “Generate a video script that accurately conveys [popularizing my travel agency in India]. The script should maintain a [travel] tone throughout, and it is intended for viewing by [social media followers and travel enthusiasts]. Please write the script in a [personal] format.” Based on the prompt 502, the script generation module 214 employs the machine-learning system 120 to generate script 216, which includes one or more visual keywords 220 and narration text 222 for each scene 218 to be included in the video 130. Specifically, the illustrated example of FIG. 5 depicts an instance where a scene will depict visuals pertaining to the Taj Mahal and will be played back in association with narration of “Begin your journey with the first light of day at the majestic Taj Mahal.”

In some implementations, the machine learning system 120 is further configured to output the script 216 with a summary of its understanding of the content creator's requirements, as represented by the prompt 502. This summary understanding provides a user of the computing device 104 with an opportunity to confirm whether the machine learning system 120 is interpreting input 118 as intended.

For instance, the script generation module 214 is configured to output the script 216 with a summary statement indicating “I understand that you want to create a promotional short video for your travel agency in India. The video will be aimed at social media followers, existing and potential customers, and be tailored to a travel-themed mood. Based on your requirements, here is a detailed script framework for the video:”

This summary of the machine learning system 120's understanding at the time of script generation advantageously provides a content creator with an opportunity to tweak inputs prior to final generation of the video content, thus offering a feedback mechanism where the content creator can fine-tune how the system generates the video content. This ongoing conversation with the machine learning system 120 enables iterative refinement, which is an advantage offered by the video generation system 116 that is not afforded by conventional video generation approaches. Users are thus enabled to modify any aspect of the proposed script 216, either manually by changing one or more visual keywords 220 or narration text 222 for a scene, by inputting a description of the required changes to an input field separate from the script (e.g., in the input field 302), combinations thereof, and so forth.

This iterative process allows for multiple rounds of refinement, ensuring that the final video content accurately reflects the user's vision and requirements. The video generation system 116's ability to adapt based on user feedback enhances its flexibility and effectiveness in producing customized video data 122, addressing potential misinterpretations or oversights early in the creation process and thus avoiding scenarios where computational resources are needlessly wasted by generating video data that does not align with a user's intent.

In some implementations, the script generation module 214 presents the script 216 (e.g., via the user interface 128) with options to accept or modify individual scenes 218 (e.g., accept or modify the proposed visual keywords 220 and narration text 222 for the scene). Returning to FIG. 2, in response to receiving input accepting the script 216 (e.g., responsive to user input selecting a “Create Video” icon displayed alongside the script 216 in the user interface 128), the script generation module 214 provides the script 216 to a data acquisition module 224. Based on the script, data is obtained for each of a plurality of scenes (block 708). As part of obtaining data for each of the plurality of scenes, image data including at least one of a video frame or a caption for the scene is obtained based on the at least one visual keyword and the narration text for the scene (block 710). As further part of obtaining data for each of the plurality of scenes, audio data including at least one of music or a narration for the scene is obtained based on the at least one visual keyword and the narration text for the scene (block 712). The data acquisition module 224 represents functionality of the video generation system 116 to acquire image data and audio data from at least one data store 226.

As described herein, the term “image data” refers to any visual content that is perceptible by a viewer during playback of a video. As such, in various implementations image data encompasses still images, video frames, animated graphics, textual overlays, visual effects, and other graphical elements. In some implementations, image data refers to individual frames extracted from a video sequence. Alternatively or additionally, image data refers to a series of frames that form a continuous video clip. Image data may also encompass computer-generated imagery, 3D renderings, or any other form of visual representation that can be incorporated into a video. In some implementations, image data includes metadata associated with visual elements, such as timestamps, captions, or annotations that are displayed alongside or overlaid on the visual content during video playback.

The data store 226 is configured for implementation in various configurations to support the video generation system 116. In some implementations, the data store 226 is a local storage device integrated within the computing device 104, such as a hard drive, solid-state drive, or flash memory, allowing for quick access to image data and/or audio data associated with (e.g., owned or created by) a user of the computing device 104. Alternatively or additionally, the data store 226 is implemented as a cloud-based storage system hosted by the service provider system 102, enabling centralized management of resources and facilitating access from multiple devices. Alternatively or additionally, the data store 226 is representative of a distributed storage system, with data spread across multiple remote data storage locations (e.g., servers). In some implementations, the data store 226 incorporates content delivery networks (CDNs) to optimize data retrieval (e.g., based on geographic location). Alternatively or additionally, the data store 226 includes specialized databases optimized for storing and retrieving specific types of content, such as image databases for visual assets or audio databases for music and voice-over content.

The data acquisition module 224 is configured to retrieve image data 228 and audio data 230 for each scene 218 in the script 216 from at least one data store 226. This retrieval process is based on the visual keywords 220 and narration text 222 generated for each scene, or a combination thereof. The image data 228 obtained for a scene 218 includes at least one video frame 232, which is configured to be displayed during the playback of the video 130, visually representing the content described by the visual keywords 220.

In some implementations, the image data 228 may comprise multiple video frames, still images, or a combination thereof, depending on the requirements of the scene and the visual keywords provided. In some implementations, the data acquisition module 224 is configured to generate captions 234, which visually represent the narration text 222 and are displayed as overlays or subtitles during video playback. For the audio component, the data acquisition module 224 retrieves or generates audio data 230, which encompasses various audible elements that viewers will hear during video playback. Audio data 230 is thus representative of synthesized narration, created by converting the narration text 222 into spoken words using text-to-speech technology. Alternatively or additionally, audio data 230 is representative of dialogue for the scene 218. The audio data 230 may also include music 236 that complements the mood and style of the scene (e.g., as defined by the input 118), as well as any sound effects that enhance the viewer's experience with the video 130. The data acquisition module 224 may employ various techniques to select or generate appropriate audio content, such as analyzing the tone and content of the narration text 222, considering the visual elements of the scene, and considering any style or mood parameters specified in the input 118.

In some implementations, audio data 230 is selected to span multiple scenes (e.g., a single song is selected for playback during the entire video 130 to maintain cohesion). Alternatively, in some implementations, different audio data is selected for different scenes of the video 130. In some implementations, playback of a single scene 218 may include playback of different instances of audio data 230. Thus, although described with respect to specific examples for explanatory purposes, the described techniques are not so limited and the video generation system 116 is configured to generate video data 122 using any suitable arrangement and combination of image data 228 and audio data 230.

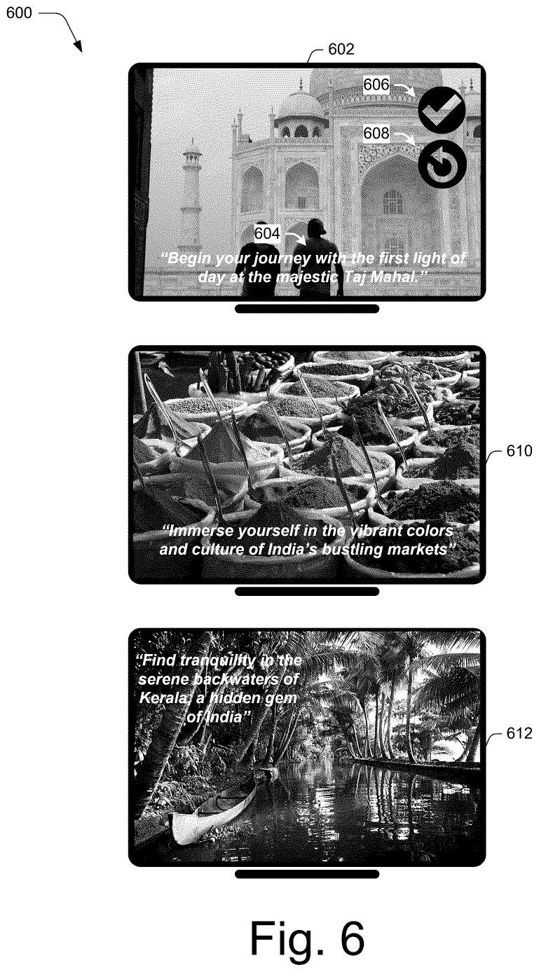

In some implementations, after the data acquisition module 224 acquires the image data 228 and the audio data 230 for each scene 218, the video generation system 116 is configured to output a preview of each scene 218 (e.g., via the user interface 128) for user review prior to final generation of the video 130. For a further description of previewing each scene 218, consider FIG. 6.

FIG. 6 depicts an example 600 of scenes 218 of video content generated based on a video script 216 generated by the script generation module 214. In the illustrated example 600, three different scenes 218 are depicted with a preview of image data 228 and audio data 230 that will be output during playback of the scene. FIG. 1 For instance, scene 602 depicts imagery featuring the Taj Mahal and a caption 604 that reads “Begin your journey with the first light of day at the majestic Taj Mahal”. Scene 602 is further displayed with an approval icon 606 and a revise icon 608, which are configured to receive user input (e.g., via the computing device 104) indicating whether the retrieved image data 228 and audio data 230 for the scene 218 is acceptable or needs to be revised. In response to receiving input at the approval icon 606, the video generation system 116 is informed that the image data 228 and the audio data 230 is acceptable for a scene. Alternatively, in response to receiving input at the revise icon 608, the video generation system 116 causes the data acquisition module 224 to modify at least one of the image data 228 or the audio data 230 for the scene 218. Although only depicted with respect to scene 602 for explanatory purposes, the video generation system 116 is configured to display the approval icon 606 and the revise icon 608 in conjunction with each scene 218, enabling users to granularly approve or revise content associated with individual scenes of the video 130.

The illustrated example 600 further depicts scene 610, which depicts visuals of a market and includes a caption reading “Immerse yourself in the vibrant colors and culture of India's bustling markets.” Further, the example 600 includes scene 612, which depicts backwater scenery and includes a caption reading “Find tranquility in the serene backwaters of Kerala, a hidden gem of India.” The example 600 thus presents image data 228 and audio data 230 for each of a plurality of scenes 218 in a structured format, enabling a user of the computing device 104 to comprehensively identify how various visual keywords 220 and narration text 222 for a scene will translate to digital content consumed by a viewer during playback of the video 130.

The video is then generated by assembling data obtained for each of the plurality of scenes and the video is represented for output in a user interface (block 714). For instance, in response to receiving input accepting the digital content for each scene 218 as acquired by the data acquisition module 224 (e.g., in response to receiving input at the approval icon 606 for each scene 218), the video generation system 116 forwards each scene 218 with its image data 228 and audio data 230 to an assembly module 238.

The assembly module 238 represents functionality of the video generation system 116 to compile the image data 228 and audio data 230 for each scene 218 into a single video 130 configured for playback via video output device 126. In some implementations, the assembly module 238 further represents functionality of the video generation system 116 to automatically adjust image data 228 and/or audio data 230 selected for inclusion in one or more scenes 218 based on the image data 228 and audio data 230 acquired for the one or more scenes. For instance, in one example a length of a voice-over (e.g., synthesized narration) causes the assembly module 238 to adjust one or more of the music played for the scene, image data displayed during the scene (e.g., a number of images, a playback duration for each image, a number of video clips, a playback duration for each video clip, transition times between different images/videos, etc.).

After automatically adjusting the image data and audio data for each scene, the assembly module 238 assembles the scenes 218 into a final video 130 and outputs the video 130 for display (e.g., via user interface 128 using video output device 126). In implementations, the video generation system 116 is further configured to provide multiple variations for the video 130 to help inspire content creators and help content creators ideate with different visions of what their video content might look like. In some implementations, these video variations are displayed alongside one another to provide an easy interface for comparing differences and understanding how different content selection affects the resulting video. Thus, although the techniques have been described herein with respect to outputting a single instance of a script 216, a single instance of a scene 218, and a single instance of a video 130 generated from combining multiple scenes 218, in implementations each stage of the video generation system 116 pipeline is configurable to output different versions simultaneously.

For instance, the prompt generation module 206 is configured to generate different variations of the prompt 208 (e.g., using different templates 210). Alternatively or additionally, the script generation module 214 is configured to generate different variations of the scene 218 (e.g., based on a single input prompt 208 or using different variations of the prompt 208), Further, the data acquisition module 224 is configured to output different previews of a scene 218, where different previews include at least one variation of image data 228 or audio data 230 relative to other previews of the same scene 218.

By presenting different options during discrete stages of the video generation pipeline, the video generation system 116 provides users with the ability to input ongoing feedback and participate in the video generation process, thus generating improved video content that minimizes consumption of computational resources, relative to conventional video generation techniques.

### Example System and Device

FIG. 8 illustrates an example system 800 that includes an example computing device 802 that is representative of one or more computing systems and/or devices that implement the various techniques described herein. This is illustrated through inclusion of the video generation system 116. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, input text describing subject matter to be conveyed in a video;
generating, by the processing device and based on the input text, a prompt to initiate generation of a script for the video using one or more machine learning models;
presenting, by the processing device and via a user interface, the script as generated by the one or more machine learning models with at least one of an option to revise a keyword describing visual aspects of a scene in the script or an option to revise narration text for the scene in the script;
acquiring, by the processing device, image data and audio data for at least one scene of the video based on the script; and
generating, by the processing device, the video by assembling the image data and the audio data for the at least one scene of the video.

2. The method of claim 1, further comprising displaying at least one request for feedback describing the subject matter to be conveyed in the video via the user interface, wherein the input text is received via user input to the at least one request for feedback.

3. The method of claim 2, wherein the at least one request for feedback includes a request to describe an intended target audience for the video, the method further comprising receiving input describing the intended target audience for the video, wherein generating the prompt is further performed based on the intended target audience.

4. The method of claim 2, wherein the at least one request for feedback includes a request to describe an intended mood for the video, the method further comprising receiving input describing the intended mood for the video, wherein generating the prompt is further performed based on the intended mood.

5. The method of claim 2, wherein the at least one request for feedback includes a request to describe an intended style for the video, the method further comprising receiving input describing the intended style for the video, wherein generating the prompt is further performed based on the intended style.

6. The method of claim 1, wherein presenting the script as generated by the one or more machine learning models for output via the user interface comprises presenting, for each of a plurality of scenes of the video, at least one keyword describing visual aspects of the scene and narration text for the scene.

7. The method of claim 6, wherein acquiring the image data for the at least one scene of the video is performed based on the at least one keyword describing visual aspects of the at least one scene of the video.

8. The method of claim 6, wherein acquiring the audio data for the at least one scene of the video is performed based on the narration text for the at least one scene of the video.

9. The method of claim 1, wherein the image data for the at least one scene of the video includes one or more of at least one video frame, a still image, or a textual caption displayed during playback of the video.

10. The method of claim 1, wherein the audio data for the at least one scene of the video includes one or more of music or dialogue.

11. The method of claim 1, wherein acquiring the audio data for the at least one scene of the video comprises generating synthesized narration for the at least one scene of the video.

12. The method of claim 1, wherein generating the prompt is performed by filling out a template based on the input text.

13. The method of claim 1,
further comprising generating a revised prompt to initiate generation of a revised script for the video using the one or more machine learning models, responsive to input at the option to revise the keyword or the option to revise the narration text.

14. The method of claim 1, further comprising displaying a preview of at least one scene in the video that includes the image data and the audio data acquired for at the least one scene of the video in the user interface, wherein generating the video is performed responsive to user input accepting the preview of the at least one scene in the video.

15. A system comprising:
one or more processors; and
a computer-readable storage medium storing instructions that, responsive to execution by the one or more processors, cause the one or more processors to:
receive input text describing subject matter to be conveyed in a video and one or more parameters for generating the video;
generate, based on the input text and the one or more parameters, a prompt to initiate generation of a script for the video using at least one machine learning model;
present the script in a user interface by displaying, for each of a plurality of scenes of the video, at least one keyword describing visual aspects of the scene and narration text for the scene;
acquire image data and audio data for each of the plurality of scenes of the video based on the script; and
generate the video by assembling the image data and the audio data for each of the plurality of scenes.

16. The system of claim 15, wherein the instructions further cause the one or more processors to display a preview of at least one scene in the video that includes the image data and the audio data acquired for at the least one scene of the video in the user interface, wherein the one or more processors generate the video responsive to user input accepting the preview of the at least one scene in the video.

17. The system of claim 15, wherein the script is presented in the user interface with at least one of:
an option to revise a keyword describing visual aspects of a scene in the script; or
an option to revise narration text for the scene in the script; and
the instructions further cause the one or more processors to generate a revised prompt to initiate generation of a revised script for the video using the at least one machine learning model, responsive to input at the option to revise the keyword or the option to revise the narration text.

18. The system of claim 15, wherein the image data for the at least one scene of the video is acquired based on the at least one keyword describing visual aspects of the at least one scene of the video and the audio data for the at least one scene of the video is acquired based on the narration text for the at least one scene of the video

19. A computer-readable storage medium storing instructions that are executable by a processing device to perform operations comprising:
generating, based on input text describing subject matter to be conveyed by a video and parameters for the video, a prompt to initiate generation of a script for the video;
generating the script for the video by inputting the prompt to generative artificial intelligence implemented using one or more machine learning models;
acquiring image data and audio data for a scene of the video based on the script;
displaying a preview of at least one scene in the video that includes the image data and the audio data acquired for at the least one scene of the video; and
generating the video by assembling the image data and the audio data for the at least one scene of the video responsive to user input accepting the preview of the at least one scene in the video.

20. The computer-readable storage medium of claim 19, the operations further comprising:
generating multiple variations of the video by:
acquiring at least one of different image data or different audio data for the at least one scene of the video based on the script; and
assembling at least one of the different image data or different audio data for the at least one scene of the video; and
outputting the video and the multiple variations of the video for display via a user interface.
